(19) United States
(12) Patent Application Publication
(10) Pub. No.: US 2018/0104141 A1
(43) Pub. Date: Apr. 19, 2018

(54) INTERACTIVE PHALLIC VIBRATOR

(71) Applicant: Trevor Shaw, Salt Lake City, UT (US)

(72) Inventor: Trevor Shaw, Salt Lake City, UT (US)

(21) Appl. No.: 15/293,202

(22) Filed: Oct. 13, 2016

(51) Int. Cl. A61H 19/00; A61H 23/02

(52) U.S. Cl. CPC A61H 19/44; A61H 23/0254; A61H 2201/5025; A61H 2201/5035; A61H 2201/5048; A61H 2201/0103; A61H 2201/5015; A61H 2201/5097

(57) ABSTRACT

A phallic vibrator is provided for stimulating female genitalia, the vibrator comprising one or more speakers, a microphone, a transmitter, and a receiver for facilitating interactive connectivity with a remotely situated user during vibratory function.

### BACKGROUND OF THE INVENTION

### Field of the Invention

This invention relates to massaging implements, and more particularly relates to a vibrating implement for stimulation of female genitalia.

### Description of the Related Art

Physical intimacy between male and females is often unsatisfactory for females because during copulation the male typically climaxes faster and becomes temporarily physiologically unable to continue sexual function after climaxing. Aside from the simple sense of well-being females wish to derive from climactic sexual experiences, sexual dissatisfaction can lead to divorce and infidelity. Mutual gratification during sexual activity is desirable to prevent this strain in romantic relationships.

Another cause of strain in marriage and romance is a partner who is constantly traveling, who resides or works distantly, and who is not physically available. Imaging the presence of another's romantic partner during their absence would be improved with real-time communication between partners away from one another. There exists no means in the art of bringing these couples together distantly for a romantic encounter.

Even when together, many couples rely on manual stipulation of the female genitalia to heighten erotic excitement of the female in attaining orgasm, and a number of devices have developed in the art for the purpose of supplementing the stimulation of the female partner during copulation. These devices are designed to engage the erogenic surfaces of the female genitals during copulation. Initially, these devices were to design to have no automatic function of their own, but rather to produce erotic stimulation with hand movements, which are often tiring to one partner or another.

With time, phallic-shaped vibrating devices for female stimulation emerged in the art, however there are no efficient devices in the art which include communication and vibration function. There is a need in the art for a vibrating device which can be used by a female to engage genitalia while hearing verbal communication from a romantic partner while, all while in stimulation of a male and female couple engaged in copulation.

The principal object of this invention is to produce a vibrator device to be used during copulation whereby orgasm of the female can be attained easily and without uncertainty while the female is in verbal contact with a partner, as well as achieved resultant beneficial effects for the marital and romantic relationship, all while reducing conjugal unhappiness and incidental romantic strains.

With the above and other objects in view. a specific embodiment of the present invention will now be described merely by way of example, with reference to the accompanying drawings thereof.

### SUMMARY OF THE INVENTION

From the foregoing discussion, it should be apparent that a need exists for in interactive vibrator. Beneficially, such a vibrator would overcome many of the difficulties with prior art by providing a means for imparting vibratory effect to the genitalia of a female user while also facilitating interactivity between a user of the vibrator and a remote user.

The present invention has been developed in response to the present state of the art, and in particular, in response to the problems and needs in the art that have not yet been fully solved by currently available apparati. Accordingly, the present invention has been developed to provide an interactive phallic vibrator, the vibrator comprising: an elongated polymeric cylindrical housing in the shape of a phallus; a rotating knob which is rotatable axially relative to the housing such that an RPM of an internal motor is increasing with rotation, the knob comprising: one or more speakers; a play button; volume controls; a track advance button; a track back button; a USB charging indicator; a detachable polymeric sleeve defining a hollow interior recess for receiving the elongated polymeric cylindrical housing.

The detachable polymeric sleeve may comprise a plurality of protuberances for increasing stimulation to female genitalia. The one or more speakers may be disposed in a recess on a top surface of the rotating knob.

The vibrator of claim 1, may comprise a plurality of detachable, flexible sleeves. The cylindrical housing may be inflated with air.

The cylindrical housing may be partially filled with one of viscoelastic polyurethane foam and silicone gel.

Another interactive phallic vibrator is provided , the vibrator comprising: an elongated polymeric cylindrical housing in the shape of a phallus; a rotating knob which is rotatable axially relative to the housing such that an RPM of an internal motor is increasing with rotation, the knob comprising: one or more speakers; an acoustic-to-electrical transducer; a play button; volume controls; a track advance button; a track back button; a USB charging indicator; a detachable polymeric sleeve defining a hollow interior recess for receiving the elongated polymeric cylindrical housing; and means for relaying and receiving electrical signals enabling device-to-device oratory communication simultaneously in accordance with core specifications of one or more subsets of Bluetooth® profiles, wherein the core specifications comprise one or more of: the Cordless Telephony Profile (CTP), the Device ID Profile (DIP), the Dial-up Networking Profile (DUN), the File Transfer Profile (FTP), the Hands-Free Profile (HFP), the Human Interface Device Profile (HID), the Headset Profile (HSP), and the Intercom Profile (ICP), the Proximity Profile (PXP).

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a top elevational perspective view of a phallic vibrator with Bluetooth® connectivity in accordance with the present invention;

FIG. 2 is a side perspective view of a phallic vibrator with Bluetooth® connectivity in accordance with the present invention;

FIG. 3A is a side perspective view of a phallic vibrator with Bluetooth® connectivity in accordance with the present invention;

FIG. 3B is a sectioned side perspective view of a phallic vibrator with Bluetooth® connectivity in accordance with the present invention.

FIG. 4 is a bottom perspective view of a phallic vibrator with Bluetooth® connectivity in accordance with the present invention; and

FIG. 5 is a top perspective view of a phallic vibrator with Bluetooth® connectivity in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

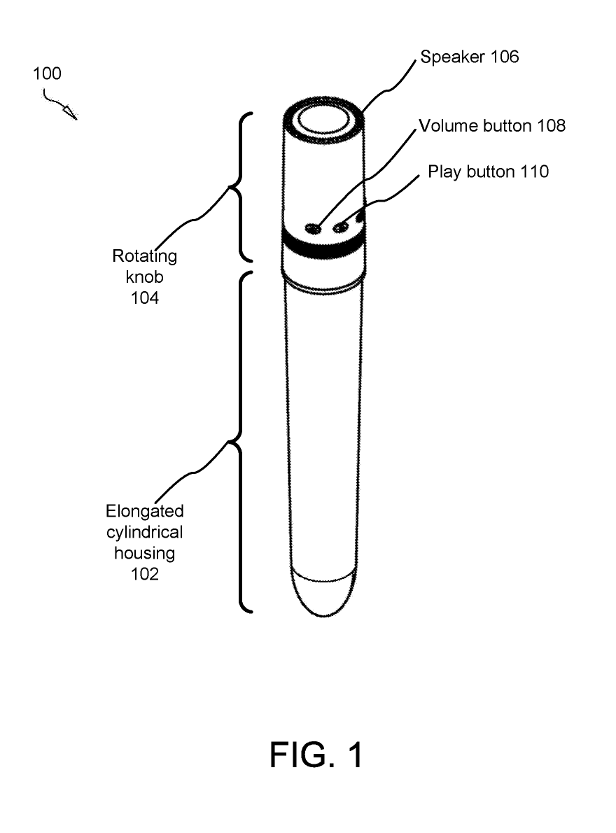

FIG. 1 is a top elevational perspective view of a phallic vibrator 100 with Bluetooth® connectivity in accordance with the present invention. The vibrator 100 comprises a elongated cylindrical housing 102 and a rotating knob 104 having a speaker 106, a volume button 108, and a play button 110.

It is an object of the present invention to enhance sexual response by simulating a frantic sexual encounter.

As further described below, the vibrator 100 comprises oscillation means necessary to cause the cylindrical housing 102 of the vibrator 100 to vibrate in response to user activation or adjustment of digital, virtual or analog controls forming part of the vibrator 100. In various means, speed control of the vibrator 100 is placed in the control of a remote user using Bluetooth® technology integrated into the vibrator 100. The vibrator 100 may response to wireless input signals from a remote users via a WAN (wide area network) or LAN (local area network). The vibrator 100 may interconnect with a PBX, cordless base station, or via a wireless communication terminal.

The vibrator 100 comprises the control circuity necessary to facilitate interactivity between a manual user of the device and a remote user of the device using wireless or Bluetooth® technology. The vibrator 100 comprises means for relaying and receiving electrical signals enabling device-to-device oratory communication simultaneously.

The means for relaying and receiving electrical signals may be implemented in accordance with core specifications of one or more subsets of Bluetooth® profiles. The core specifications may comprise inter alia one or more of: the Cordless Telephony Profile (CTP), the Device ID Profile (DIP), the Dial-up Networking Profile (DUN), the File Transfer Profile (FTP), the Hands-Free Profile (HFP), the Human Interface Device Profile (HID), the Headset Profile (HSP), and the Intercom Profile (ICP), the Proximity Profile (PXP).

In the shown embodiment, the vibrator 100 may be configured to make use of the Bluetooth protocols and procedures enabling device-to-device intercommunication connectivity. This functionality may be provided by incorporating the Bluetooth Intercom Profile® and/or the Bluetooth Telephony Profile®.

When the vibrator 100 is used to physically engage female genitalia within a bodily orifice, the imparted motion to the housing 102 from a motor housed internally realizes sexual function in the user.

The vibrator 100 may be selectively operated at low, medium or high settings, as desired by the user, by twisting or rotating the top cap in a clockwise or counterclockwise direction.

The speaker 106 may be recessed into the top surface of the knob 104. In various other embodiments, the knob 104 comprises a plurality of speakers 106 which may be disposed beneath apertures or open ends of the knob 104 for increasing emulation of sound into the ambient air. The speaker 106 may comprise an electrical-to-acoustic transducer for playing oratory sound originating with a partner interconnected via the vibrator 100 from a distance.

Alternatively, the speaker 106 may be purposed for playing music and/or prerecorded effects of a sexually arousing nature written in computer readable memory within the vibrator 100.

The volume button 108 is configured to raise or lower a volume of sound emanating from the speaker 106 when depressed and is known to those of skill in the art. The volume button 108 may comprise a digital or analog switch, or may be a virtual button displayed on a GUI or touch-responsive display integrated into the vibrator 100.

The cylindrical housing 102 forms a tubular, conical or phallic elongated member with a convex end cap at the lower surface of the vibrator 100. In various embodiments, the housing 102 is formed from polymeric, metallic, metallic alloy, or organic materials known to those of skill in the art, including nylon, steel, and leather.

The cylindrical housing 102 inserts into the receiving end of a detachable flexible sleeve which envelopes the cylindrical housing and which forms the outer surface of the vibrator 100 in some embodiments. The detachable flexible sleeve thereafter engages the genitalia of a female user. In other embodiments, the exterior surface of the cylindrical housing 102 is used to engage directly and stimulate sensitive female nerve centers.

The cylindrical housing 102 has an open top end and closed bottom end and defines a hollow recess for housing various electrical and electromechanical components of the vibrator 100 as further described below.

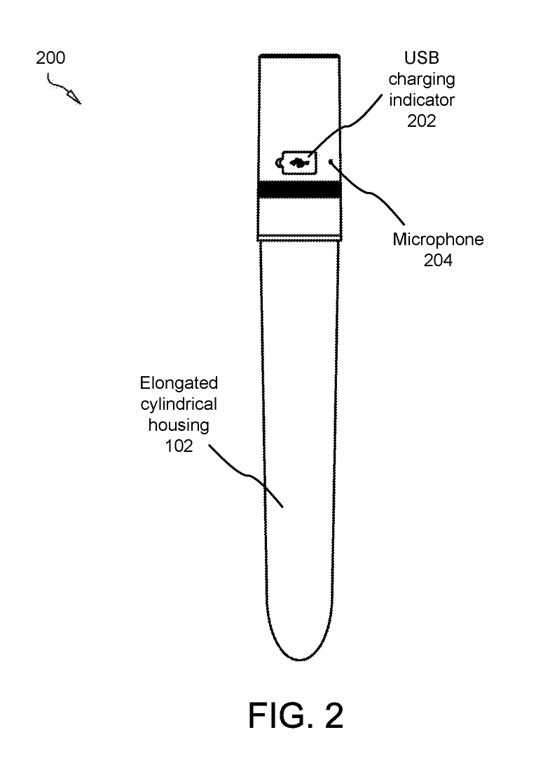

FIG. 2 is a side perspective view of a phallic vibrator 200 with Bluetooth® connectivity in accordance with the present invention. The vibrator 200 comprises an elongated cylindrical housing 102, a USB charging indicator 202, and a microphone 204.

The microphone 204 converts sound waves into a digital signal and is well-known to those of skill in the art. The microphone 204 facilitates verbal communication between a user of the vibrator 200 and a remote user interfaces with the vibrator 200 and user on a WAN or LAN. The microphone 204 is in logical connectivity with a processor and a transmitter housed interiorly to the vibrator 200. Using the microphone 204, a user making use of the vibrator 200 can speak to the remote user, and an in person sexual experience can be shared by both remotely.

The microphone 204 may comprise an acoustic-to-electrical transducer configured to convert oratory sound from a user into an electrical signal for relay to a partner.

The vibrator 200 may comprise a USB charging indicator, which may consist of an LED, for the purpose of indicating connectivity between the vibrator 200 and an external DPD via a USB cable. In various embodiments, the USB cable is used to charge a battery internal to the vibrator 200.

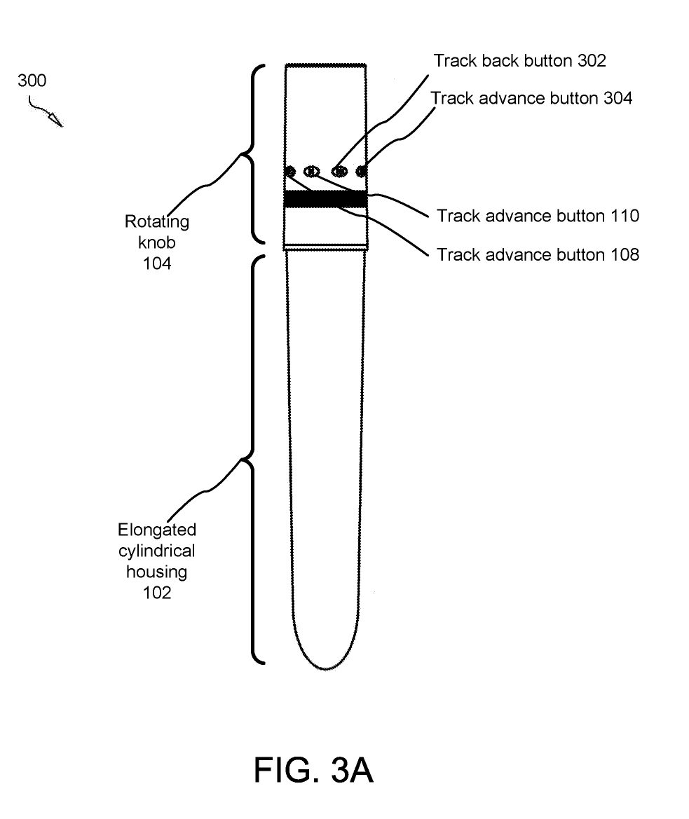

FIG. 3A is a side perspective view of a phallic vibrator 300 with Bluetooth® connectivity in accordance with the present invention. The vibrator 300 comprises an elongated cylindrical housing 102 and a rotating knob 104 having a track back button 302 and track advance button 304.

The track back button 302 functions to reset play of an MP3 or other compressed format audio recording in computer readable memory. The track forward button 304 functions to advance play of an audio file in computer-readable memory to a subsequent audio file. In various embodiments, the buttons 302, 304 may signal a data processing device (DPD) to transmit media, including audio, to the vibrator 300 over a WAN. The buttons 302, 304 may comprise analog switches, or digital or virtual controls.

FIG. 3B is a sectioned side perspective view of a phallic vibrator 350 with Bluetooth® connectivity in accordance with the present invention. The vibrator 350 comprises a motor 356, a battery 358, a transmitter 360, a receiver 362, and a memory 364.

In various embodiments, the vibrator 350 comprises a battery 358 which is housed within the polymeric cylindrical housing 102. A battery 358 is well-known to those of skill in the art.

The vibrator 350 may comprise a motor 356 which is activated in response to axial rotation of the knob 104. The motor 356 operates to spin a shaft to which an eccentric weight is mounted, which eccentric weight causes the vibrator 350 to vibrate as it the motor 356 RPM increases, imparting vibratory effect. When the knob 104 is rotated axially, the motor 356 speed (RPM) increases, increasing the frequency and intensity of the vibrations imparted to the vibrator 350.

The vibrator 350 may comprise a processor with the circuity necessary to adjust motor speed in response to wireless input from a remote user received via the receiver 362.

The transmitter 360 transmits a wireless signal and the receiver 362 receives a wireless signal. The transmitter 360 and receiver 362 are known to those of skill in the art.

The vibrator 350 comprises, in some embodiments, computer readable memory for storing compressed audio files in various formats, including WAV and MP3. In various embodiments, these audio files comprise recordings of a lover, love interest, spouse and/or romantic partner's fawning or audio of sexual nature.

The vibrator 350 may be configured to play these audio files through the speaker 106 during vibratory use of the apparatus 350.

In various embodiments, this sheath for flexible sleeve 352 may comprise a phallic-shaped, or cylindrical, polymeric sleeve having a plurality of protuberances at regularly-spaced intervals for heightening stimulatory effect on female genitalia. The sleeve 352 may also define and/or comprise a textured surface, conical protrusions, or irregularly-shaped recesses. The sleeve 352 is detachable and interchangeable with a variety of other sleeves 352.

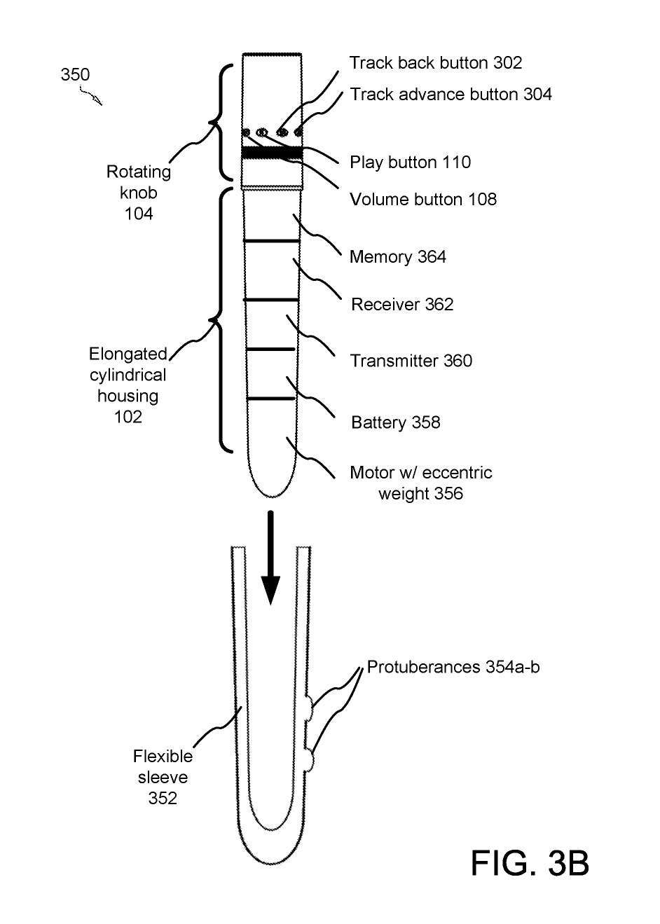

FIG. 4 is a bottom perspective view of a phallic vibrator 400 with Bluetooth® connectivity in accordance with the present invention.

As shown, the speaker 106 is recessed into the top surface of the vibrator 400.

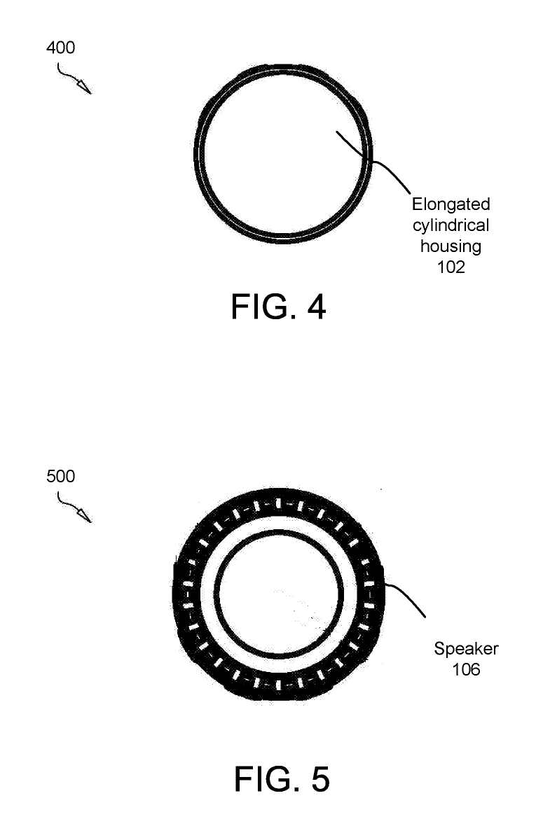

FIG. 5 is a top perspective view of a phallic vibrator 500 with Bluetooth® connectivity in accordance with the present invention.

As shown, the bottom surface of the vibrator 500 comprises a closed, convex end cap which may be integrated into the cylindrical housing 102 and formed as a single integrated piece.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An interactive phallic vibrator, the vibrator comprising:
an elongated polymeric cylindrical housing in the shape of a phallus;
a rotating knob which is rotatable axially relative to the housing such that an RPM of an internal motor is increasing with rotation, the knob comprising:
one or more speakers;
a play button;
volume controls;
a track advance button;
a track back button;
a USB charging indicator;
a detachable polymeric sleeve defining a hollow interior recess for receiving the elongated polymeric cylindrical housing; and
means for relaying and receiving electrical signals enabling device-to-device oratory communication simultaneously.

2. The vibrator of claim 1, wherein the means for relaying and receiving electrical signals is implemented in accordance with core specifications of one or more subsets of Bluetooth® profiles.

3. The vibrator of claim 2, wherein the core specifications comprise one or more of:
the Cordless Telephony Profile (CTP), the Device ID Profile (DIP), the Dial-up Networking Profile (DUN), the File Transfer Profile (FTP), the Hands-Free Profile (HFP), the Human Interface Device Profile (HID), the Headset Profile (HSP), and the Intercom Profile (ICP), the Proximity Profile (PXP).

4. The vibrator of claim 1, wherein the means for relaying and receiving electrical signals is implemented in accordance with a subset of Bluetooth profiles.

5. The vibrator of claim 1, wherein the detachable polymeric sleeve comprising a plurality of protuberances for increasing stimulation to female genitalia.

6. The vibrator of claim 1, wherein the one or more speakers are disposed in a recess on a top surface of the rotating knob.

7. The vibrator of claim 1, further comprising a plurality of detachable, flexible sleeves.

8. The vibrator of claim 1, further comprising a microphone.

9. The vibrator of claim 1, wherein the cylindrical housing is inflated with air.

10. The vibrator of claim 1, wherein the cylindrical housing is partially filled with one of viscoelastic polyurethane foam and silicone gel.

11. An interactive phallic vibrator, the vibrator comprising:
an elongated polymeric cylindrical housing in the shape of a phallus;
a rotating knob which is rotatable axially relative to the housing such that an RPM of an internal motor is increasing with rotation, the knob comprising:
a speaker;
a microphone;
a play button;
volume controls;
a track advance button;
a track back button;
a USB charging indicator;
a plurality of detachable polymeric sleeve defining a hollow interior recess for receiving the elongated polymeric cylindrical housing.

12. An interactive phallic vibrator, the vibrator comprising:
an elongated polymeric cylindrical housing in the shape of a phallus;
a rotating knob which is rotatable axially relative to the housing such that an RPM of an internal motor is increasing with rotation, the knob comprising:
one or more speakers;
an acoustic-to-electrical transducer;
a play button;
volume controls;
a track advance button;
a track back button;
a USB charging indicator;
a detachable polymeric sleeve defining a hollow interior recess for receiving the elongated polymeric cylindrical housing; and
means for relaying and receiving electrical signals enabling device-to-device oratory communication simultaneously in accordance with core specifications of one or more subsets of Bluetooth profiles, wherein the core specifications comprise one or more of: the Cordless Telephony Profile (CTP), the Device ID Profile (DIP), the Dial-up Networking Profile (DUN), the File Transfer Profile (FTP), the Hands-Free Profile (HFP), the Human Interface Device Profile (HID), the Headset Profile (HSP), and the Intercom Profile (ICP), the Proximity Profile (PXP).
